(19) United States
(12) Patent Application Publication
(10) Pub. No.: US 2009/0127392 A1
(43) Pub. Date: May 21, 2009

(54) PROTECTION DEVICE

(75) Inventors: Claus-Peter Gross, Buxtehude (DE); Stefan Krafzik, Hanstedt (DE)

Correspondence Address: INGRASSIA FISHER & LORENZ, P.C., 7010 E. COCHISE ROAD, SCOTTSDALE, AZ, 85253, US

(73) Assignee: AIRBUS DEUTSCHLAND GMBH, Hamburg (DE)

(21) Appl. No.: 12/142,475

(22) Filed: Jun. 19, 2008

Related U.S. Application Data
(63) Continuation of application No. PCT/EP2006/012317, filed on Dec. 20, 2006.
(60) Provisional application No. 60/751,898, filed on Dec. 20, 2005.

(30) Foreign Application Priority Data
Dec. 20, 2005 (DE) 2005 060 958.9

(51) Int. Cl. B64C 1/00

(52) U.S. Cl. 244/121

(57) ABSTRACT

A device is provided for protecting a structure, such as an aircraft structure. The device includes, but is not limited to a skin made of a material comprising a multitude of alternating aluminium and glass-fibre reinforced plastic layers (e.g., GLARE), each being a few tenths of a millimetre in thickness. The skin is attachable to the structure so that a space is created between the structure and the skin, into which space the skin deforms when a force acts on it, so as to absorb the force acting on the skin, thereby minimizing and preferably preventing damage to the structure.

### CROSS-REFERENCE TO RELATED APPLICATIONS

This is a continuation of International Application No. PCT/EP2006/012317, filed Dec. 20, 2006, which application claims priority to German Patent Application No. 10 2005 060 958.9 filed Dec. 20, 2005, and to U.S. Provisional Patent Application No. 60/751,898 filed Dec. 20, 2005, which are all hereby incorporated in their entirety by reference.

### TECHNICAL FIELD

The present invention relates to a device for protecting a structure, in particular for protecting an aircraft structure against a bird strike, for example.

### BACKGROUND

In order to obtain certification, commercial aircraft have to pass the so-called bird-strike test or “chicken test”. In this test the impact of a bird weighing 8 lbs during a flight at 340 kt is simulated on an aircraft structure.

In particular, the nose regions of the aircraft structure are critical regions, for which special measures have to be provided in order to pass the bird-strike text.

Normally these regions comprise structures made of aluminium sheeting, carbon fibre, glass fibre etc.

Despite these structures, time and again, bird strikes result in impact penetration of the structure and in damage to the aircraft structure, in particular in the nose regions.

Furthermore, known structures are relatively heavy, which is disadvantageous especially in the context of aircraft.

In view of the foregoing, it is at least one object to create a device that reliably prevents damage to the aircraft structure as a result of a bird strike, for example, and which device furthermore is light in weight. In addition, other objects, desirable features, and characteristics will become apparent from the subsequent summary and detailed description and the appended claims, taken in conjunction with the accompanying drawings and this background.

### SUMMARY

The at least one object, other objects, desirable features, and characteristics may be met with a device for protecting a structure. The structure includes, but is not limited to a skin made of a material comprising a multitude of alternating aluminium and glass-fibre reinforced plastic layers, each being a few tenths of a millimetre in thickness. The skin is attachable to the structure so that a space is created between the structure and the skin, into which space the skin deforms when a force acts on it, so as to absorb the force acting on the skin without damaging the structure.

The device according to an exemplary embodiment of the invention comprises a skin made of GLARE, which skin can be affixed to a structure, such as an aircraft structure), to be protected. The skin can be affixed or attached by riveting, screwing, bonding, etc., for example, to an aircraft structure such that a void or opening is created between the aircraft structure and the skin, into which void the skin deforms when a force acts on the skin, so as to absorb the force acting on the skin without damaging the structure.

The material GLARE (GLAss-fibre REinforced aluminium) comprises a multitude of layers, each being only a few tenths of a millimetre in thickness. These layers are alternately made of aluminium and of a glass fibre laminate (glass-fibre reinforced plastic). These layers are bonded to each other under pressure.

The material GLARE provides a very significant advantage in that it can absorb a lot of energy without tearing. In this process the energy is transformed leaving permanent deformation. Thus, for example, the aircraft structure that is situated behind the impact location remains undamaged to a very large extent; i.e. a bird impacting on the skin made of GLARE does not penetrate right through to the aircraft structure.

According to another exemplary embodiment, the device comprises a multitude of ribs that are located on that surface of the skin, which surface faces towards the aircraft structure.

The ribs are used for stiffening the device if this is aerodynamically required. The ribs can be necessary for aerodynamic reasons in order to avoid a change in the profile contour of the aircraft structure because a deviation of the required profile contour leads to an impairment of the aerodynamics.

The ribs comprise, for example, aluminium or GLARE or some other suitable material that causes stiffening of the device.

According to the preferred exemplary embodiment, the ribs are made of aluminium, which results in a weight reduction of up to 25%.

The ribs can be connected to the skin, for example by bonding, riveting, bonding and riveting, screwing etc.

### BRIEF DESCRIPTION OF THE DRAWINGS

Below, a preferred exemplary embodiment is described with reference to the enclosed figures, wherein in the figures the same reference characters are used for identical components, and

FIG. 1 shows a perspective view of a device according to the exemplary embodiment; and

FIG. 2 shows a lateral top view of the device according to FIG. 1 in an installed state.

### DETAILED DESCRIPTION

The following detailed description is merely exemplary in nature and is not intended to limit application and uses. Furthermore, there is no intention to be bound by any theory presented in the preceding summary and background or the following detailed description of the invention.

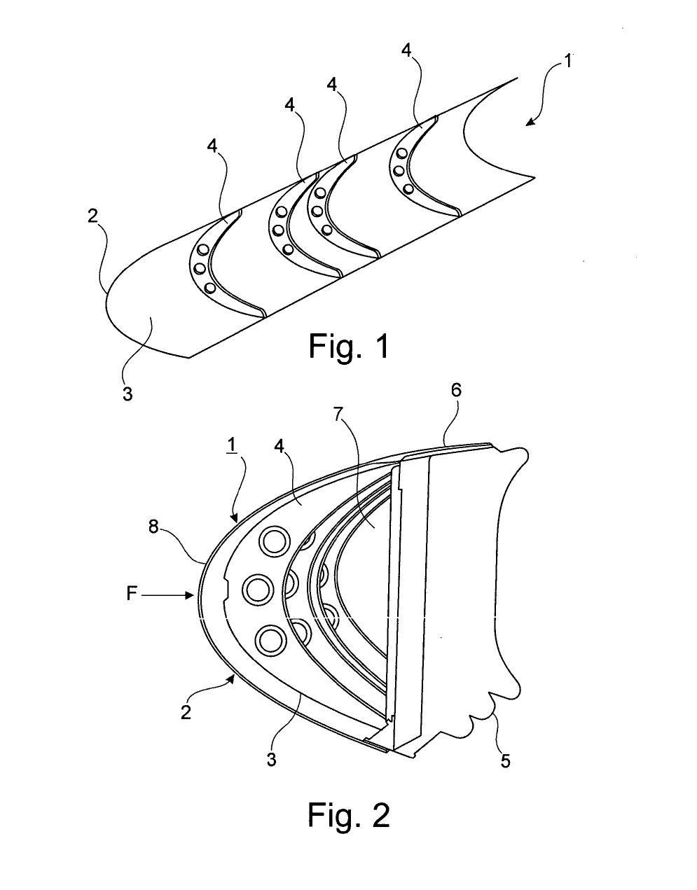

FIG. 1 shows a perspective view of a device 1 for protecting an aircraft structure (not shown), for example in the region of the nose of an aircraft.

The device 1 comprises a skin 2 made from the material GLARE. According to the preferred exemplary embodiment, on a surface 3 of the skin 2, which surface faces the aircraft structure (not shown), a multitude of ribs 4 are arranged in order to stiffen the device 1 if this is aerodynamically required. According to an alternative exemplary embodiment, the ribs 4 can also be left out.

According to the preferred exemplary embodiment shown in FIG. 1, the ribs 4 are crescent shaped; however, they can have any desired shape. The ribs 4 are, for example, arranged so as to be equidistant from each other; however, they can also be arranged so as to be spaced apart from each other at different spacings according to aerodynamic requirements.

According to the preferred exemplary embodiment, the ribs are, for example, also made of GLARE or aluminium, and are, for example, bonded, glued, screwed, riveted or connected in some other way to the skin surface 3.

FIG. 2 shows a somewhat perspective top view of the device 1 that is affixed to an aircraft structure 5 to be protected.

The device 1 is, for example, in a region 6 screwed, bonded, glued, riveted etc. or otherwise firmly connected to the aircraft structure 5.

As shown in FIG. 2, a void or space 7 is formed between the skin 2 of the device 1 and the aircraft structure 5. This void 7 provides a buffer zone in order to absorb a force (F) that acts on an exterior surface 8 of the skin 2, in that the skin 2 deforms in the direction of the aircraft structure 5, i.e. into the void 7. In this arrangement the size of the void 7 matches the aerodynamic requirements, the profile contour of the aircraft structure, as well as the deformation characteristics of the GLARE material so as to prevent damage to the aircraft structure 5 from occurring.

Although according to the preferred exemplary embodiment stiffening ribs are provided for the device 1, the skin 2 made of GLARE is sufficiently rigid to preferably maintain its shape (for example matched to a nose) by itself.

Although the exemplary embodiments have been described above with reference to a preferred exemplary embodiment, it goes without saying that modifications and changes can be made without leaving the protective scope of the invention. Furthermore, the invention can be used not only in aircraft engineering but also in other areas, for example in automotive engineering, to protect a structure against the effect of a force. Moreover, while at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for protecting a structure, comprising:
a plurality of aluminium layers having a thickness of tenths of a millimetre; and
a plurality of glass-fibre reinforced plastic layers alternating with the plurality of aluminium layers to form a skin, said plurality of glass-fibre reinforced plastic layers having the thickness of tenths of the millimetre,
wherein the skin is attachable to the structure so that a space is created between the structure and the skin,
wherein the skin is configured to deform into the space when acted upon by a force so as to at least substantially absorb the force acting on the skin.

2. The device of claim 1, comprising a plurality of ribs that are located on a surface of the skin and the surface faces towards the structure.

3. The device of claim 2, wherein the plurality of ribs are adapted to match a profile contour of the structure.

4. The device of claim 2, wherein the plurality of ribs are made of aluminium and having the thickness of tenths of the millimetre.

5. The device of claim 2, wherein the plurality of ribs are made of a material comprising a plurality of aluminium and glass-fibre reinforced plastic layers, each of said plurality of aluminium and glass-fibre reinforced plastic layers having the thickness of tenths of the millimetre.

6. The device of claim 1, wherein if a force acts on the skin, said skin remains permanently deformed.

7. The device of claim 2, wherein the plurality of ribs are at least one of glued, screwed, riveted and bonded to the skin.

8. The device of claim 1, wherein the skin is glued to the skin.

9. The device of claim 1, wherein the skin is screwed to the skin.

10. The device of claim 1, wherein the skin is riveted to the skin.

11. The device of claim 1, wherein the skin is bonded to the skin.

12. The device of claim 1, wherein the structure is an aircraft structure.
